(19) United States
(12) Patent Application Publication
(10) Pub. No.: US 2026/0049476 A1
(43) Pub. Date: Feb. 19, 2026

(54) ROOFING TROLLEY

(71) Applicant: John Fisk Stout, Cottonwood Heights, UT (US)

(72) Inventor: John Fisk Stout, Cottonwood Heights, UT (US)

(21) Appl. No.: 18/802,503

(22) Filed: Aug. 13, 2024

(51) Int. Cl. E04D 15/00; B62B 1/26

(52) U.S. Cl. CPC E04D 15/003; B62B 1/26; B62B 2202/48

(57) ABSTRACT

A roofing trolley. There is a carriage body, including: a first pair of wheels spaced apart from each other, and positioned and sized to support the carriage body; and an axle disposed interior to the first pair of wheels; a knife mount coupled to the axle, and including a bracket protruding therefrom, wherein the knife mount is selectably rotatable; a hooked knife slidably coupled to the bracket of the knife mount; and a handle extending from the carriage body.

### FIELD OF THE INVENTION

The present invention relates to roofing tools, specifically trolleys and knives for cutting shingles.

### DESCRIPTION OF THE RELATED ART

In the related art, it has been known to use knives and other tools for roofing. When installing a “tear-off” roof, the old roof must first be removed. Unlike re-roofing, which involves laying down a new layer of shingles on top of your old roofing material, a complete roof replacement involves tearing off every layer of a roof and replacing it. Accordingly, shingle roofing may be cut into manageable sections to make them easier to remove and dispose of.

In addition, new shingles must be shaped and trimmed to fit, such as at a gable or fascia. Shingle shears, hatchets, knives, bowtie blades, etc. are often used to cut shingles. Often, cutting as one goes with a knife is an efficient way to cut a shingle.

Roofing knives may be specially designed with extra-long handles to keep knuckles clear and safe while cutting roofing shingles. They may also have grips designed to keep the knife from slipping out of the hand. Further, roofing knives may have hooks at the end of their blades to help with controlling the cut.

Some improvements have been made in the field. Examples of references related to the present invention are described below in their own words, and the supporting teachings of each reference are incorporated by reference herein:

U.S. Pat. No.: 8,820,605, issued to Frederick E. Shelton IV, discloses a surgical instrument. Various embodiments of the surgical instrument include an end effector that has a moveable cutting implement. A main drive shaft assembly operably interfaces with the end effector for transmitting an actuation motion to the movable cutting implement therein. A gear drive train is connected to the main drive shaft assembly. The gear drive train is actuated by a motor that is configured to receive control signals from a robotic system. Various embodiments include a sensor arrangement that operably interfaces the end effector to communicate forces experienced by the end effector to the robotic system.

U.S. Pat. No.: 9,346,483, issued to Davis et al., discloses a knife includes a handle that includes a gripping surface; a blade slide positioned in a recess of the handle that extends from an opening of the handle through a cavity within the handle; a blade coupled to the blade slide near a proximal end of the blade and extending through the recess and into the opening when the blade slide is in the retracted position; and a guide coupled to the blade near a distal end of the blade opposite the proximal end, the guide including a contoured surface configured to engage a work piece to extend the blade slide a distance from the retracted position to an extended position such that the blade is extended from the opening of the handle, the blade slide biased to move from the extended position to the retracted position.

U.S. Pat. No.: 11,382,626, issued to Shelton IV et al., discloses A surgical system is disclosed. The surgical system comprises a surgical end effector, a housing configured to operably interface with a source of rotary input motions, and a first rotary output member operably supported by the housing. The surgical system further comprises a second rotary output member operably supported by the housing, a knife bar supported for rotational and axial travel, and an axially movable closure member configured to apply closure and opening motions to the second jaw. The surgical system further comprises a knife bar interface, a first rotary control interface between the first rotary output member and the knife bar, and a second rotary control interface between the second rotary output member and the knife bar.

U.S. Patent Application Publication No.: 2012/0246995A1, by Richard C. Moore JR, discloses A retractable compact knife spear is provided. The knife spear may include a knife blade, as opposed to standard barbs and may be compacted to strap to a diver's leg. The retractable knife spear may include other features, such as sound signaling devices and may be used as a pointer when leading dive teams. The retractable knife spear is useful for eradication of invasive fish species, such as the lion fish in the Caribbean and along the U.S. east coast.

Japanese Patent No: 6778246B2, discloses an elongated shaft having a distal end to the shaft: and an end effector coupled to the distal end of the shaft, wherein the end effector has a first end and a second end, and the end effector is: with a first member that is movable towards the second end of the end effector; with a knife pivotally coupled to the first member; a second member of the knife with respect to the first member during the simultaneous movement of (a) the first member and the second member towards the second end of the end effector, so as to prevent rotation movement relative to, and (b) the first member to cause rotation of the knives for stowing or the knife to permit rotation of said knife for stowing the knife as described above, with the first member and configured to continue to move toward the second end of the end effector following the simultaneous movement of the second member, the second member; end effectors, including; have, surgical instruments. The end effector is a lead screw that is operably coupled to at least one of the first member or the second member, and the connected member is connected to the lead screw in response to rotation of the lead screw. Drive along at least part of, including lead screw.

Taiwanese Patent No.: 200932452A, issued to Peter G. Schmidt and Guy Feltz, discloses a robot tool for workpiece processing, the robot-to-robot connection component, the robot tool is used to connect the cutter knife to the holding component to be held at the present position: The cut piece can be connected to the robot by the connecting element.

The inventions heretofore known suffer from a number of disadvantages which include: being slower to use, being less convenient, being harder on the body, not allowing for a perfectly straight cut, not being easy to use, being less accurate, being less stable, not allowing one to walk backwards in an upright position, and requiring one to bend over or crouch.

What is needed is a roofing trolley that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available roofing trolleys. Accordingly, the present invention has been developed to provide a roofing trolley.

In one embodiment of the invention, the roofing trolley may comprise: a carriage body, that may include: a first pair of wheels that may be spaced apart from each other, and/or positioned and/or sized to support the carriage body; and/or an axle that may be disposed interior to the first pair of wheels; a knife mount that may be coupled to the axle, and/or including a bracket protruding therefrom, wherein the knife mount may be selectably rotatable; a hooked knife that may be slidably coupled to the bracket of the knife mount; a handle extending from the carriage body; and/or a weld probe that may be coupled to the axle and/or in functional communication with the handle.

In other embodiments of the invention the knife mount may be selectably rotatable about the axle. The roofing trolley may further comprise a collar that may be fixedly coupled to the knife mount and/or selectably rotatable about the axle. The axle may be selectably rotatable and/or the knife mount may be fixedly coupled to the axle. The roofing trolley may further comprise a second pair of wheels that may be disposed opposite the first pair of wheels such that the axle may be disposed between the first pair and/or the second pair.

In yet further embodiments of the invention, the collar may include a wing screw that may be rotatably coupled to the collar. The bracket may include a clamp and/or a screw bolt that may be removably coupled to the clamp. The first pair of wheels may be the only wheels. The hooked knife may include a hooked blade that may be oriented to cut in the direction of the handle. The axle may be coplanar with the rotational axis of the wheels.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention. Also, the roofing trolley may comprise: a second pair of wheels that may be spaced apart from each other, and/or spaced apart from the first pair of wheels; and/or a second axle that may be disposed interior to the second pair of wheels.

These features and advantages of the present invention will become more fully apparent from the following description and appended claims or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a side perspective view of a roofing trolley, according to one embodiment of the invention;

FIG. 2 is a partial side perspective view of a roofing trolley showing a carriage body, according to one embodiment of the invention;

FIG. 3 is a top plan view of a roofing trolley, according to one embodiment of the invention;

FIG. 4 is a side elevational view of a hooked knife of a roofing trolley with a first wheel removed, according to one embodiment of the invention;

FIG. 5 is a side perspective view of a roofing trolley showing a weld probe, according to one embodiment of the invention; and

FIG. 6 is a side elevational view of a roofing trolley, according to one embodiment of the invention.

### DETAILED DESCRIPTION OF THE INVENTION

For the purpose of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

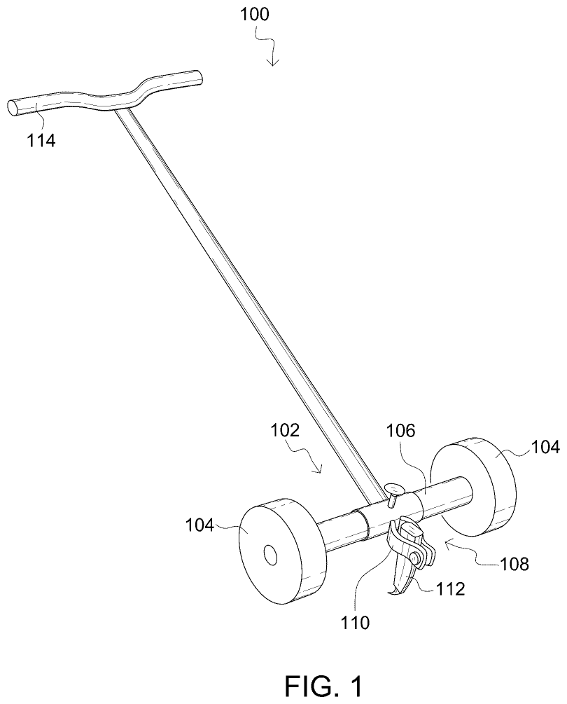

FIG. 1 illustrates a side perspective view of a roofing trolley, according to one embodiment of the invention. There is shown a roofing trolley 100 that includes a carriage body 102. A first pair of wheels 104 are coupled to the carriage body 102 with an axle 106 disposed between the wheels 104. A knife mount 108 is coupled to the axle 106 and includes a bracket 110. A hooked knife 112 is disposed within the bracket 110. The roofing trolley 100 also includes a handle 114 coupled to the carriage body 102.

The illustrated roofing trolley 100 may be a utility trolley or cart for moving and transporting tools. For instance, the roofing trolley 100 may be a trolley for moving and using roofing tools such as, but not limited to, knives, hatchets, nailers, shovels, and seam probes. In one non-limiting embodiment, the roofing trolley may be such as a utility trolley wheeled carriage for transport of roofing tools and materials.

As illustrated, the roofing trolley has a carriage body 102. The carriage body 102 may be frame or a structure for carrying tools. Accordingly, tools may be coupled to the carriage body 102 for transport and use. For example, the roofing trolley 100 and carriage body 102 may be such as a body of a 2-or 4-wheeled lawn mower, a paint line striper with wheels, or a wheeled fertilizer spreader.

The illustrated carriage body 102 includes an axle 106 and a first pair of wheels 104. The first pair of wheels 104 are spaced apart from each other and positioned and sized to support the carriage body 102. The axle 106 is disposed interior to the pair of wheels 104. The axle 106 may be a rod or spindle (either fixed or rotating) passing through the center of a wheel or group of wheels. Accordingly, the pair of wheels 104 and axle 106 may be used to lift and move objects coupled to, or disposed on, the carriage body 102. It is further understood that the wheels 104 may be comprised of casters, or any other type of wheel such as complete wheels, cast wheels, flanged wheels, fixed wheels, etc.

Additionally illustrated, a knife mount 108 is shown coupled to the carriage body 102. The knife mount 108 is coupled to the axle 106 and includes a bracket 110 protruding therefrom. A position of the knife mount 108 and bracket 110 may be adjusted both horizontally and vertically along the axle 106. A knife 112 may be coupled to the bracket 110 of the knife mount 108. Accordingly, both the knife mount 108 and the bracket 110 may be positioned, sized, and/or shaped for receiving and holding tools in place.

As illustrated, a hooked knife 112 is coupled to the bracket 110 of the knife mount 108. The hooked knife 112 may be slidably, removably, and adjustably coupled to the bracket 110. Accordingly, tools, other than knives or hooked knives, may also be coupled to the knife mount 108. As shown, a hooked knife 112 is coupled to the knife mount 108. The hooked knife 112 may be a blade with a hook-shape at an end of the blade. The hooked knife 112 may be used for accurately trimming and cutting building materials such as shingles and carpet. For instance, the hooked knife 112 may be such as the Hook Knife BG101 by Pittsburgh Spray Equipment Co. of 3601 Library Rd., Pittsburgh, Pa 15234, which is incorporated by reference herein.

The illustrated roofing trolley 102 also includes a handle 114 extending from the carriage body 102. The handle 114 may be used for pushing, pulling, driving, controlling, etc. the carriage body 102 along a surface. For example, in one non-limiting embodiment of the invention, the roofing trolley 100 and its parts and components, including the handle 114, may be such as the Striping Paint Machine of ULINE at 12575 Uline Drive, Pleasant Prairie, WI 53158, which is incorporated by reference herein.

In one non-limiting embodiment, there is a roofing trolley 100 with a mount 108 that adjusts up and down. A knife mount 108 may be attached to an axle 106 and may be swiveled up and down and tightened. A bracket 110 may hold a knife 112 that may have a hooked blade. The knife 112 may be adjusted by swiveling the knife mount 108 around the axle 106 to raise the knife up or down. Likewise, the bracket 110 itself may also be swiveled up or down, such as with a wing nut adjustment.

In operation, of one embodiment of the invention, a position of an axle 106 of a roofing trolley 100 may be adjusted along a carriage body 102. A position of a knife mount 108, coupled to the axle 106, may be adjusted both horizontally and/or vertically along the axle 106. Similarly, a position of a bracket 110, coupled to the knife mount 108, may also be adjusted. When the axle 106, knife mount 108, and/or bracket 110 are in a desired position, a tool, such as a knife, may be coupled to the bracket 110 of the knife mount 108. Once a tool, such as a hooked knife 112, has been coupled to the roofing trolley 100, a user may put pressure on the knife 112 and walk backwards while pulling on a handle 114 of the trolley 100 to cut a surface without having to bend over.

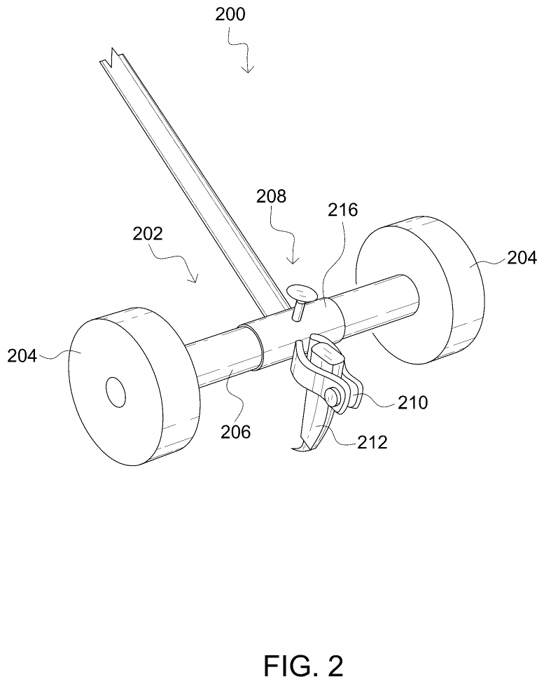

FIG. 2 illustrates a partial side perspective view of a roofing trolley showing a carriage body, according to one embodiment of the invention. The illustrated roofing trolley 200 is shown to include a carriage body 202. A first pair of wheels 204 are coupled to the carriage body 202 along an axle 206. A knife mount 208, including a bracket 210, is coupled to the axle 206 and protrudes therefrom. A hooked knife 212 is coupled to the knife mount 208. The knife mount 208 also includes a collar.

As shown, the axle 206 may be rotatable. The axle 206 may be rotatable by a driving power or force such that as the axle rotates, the first pair of wheels 204 also rotate. In one non-limiting embodiment, the illustrated axle 206 may also be selectably rotatable such as by tightening an axle nut with a torque wrench. Accordingly, the axle 206 may be selectably rotatable and the knife mount 208 may be fixedly coupled to the axle 206.

In addition, the illustrated knife mount 208 includes a collar 216, and is selectably rotatable about the axle 206. The collar 216 is fixedly coupled to the knife mount 208 and is selectably rotatable about the axle. Accordingly, the illustrated knife mount 208 is selectably rotatable about the axle 206 such that a height or angle of the bracket 210 protruding from the knife mount 208 may be selected and adjusted. For instance, the bracket 210 may protrude at a variety of angles, such as forty-five degrees from a surface, parallel to a surface, fifty-five degrees to a surface, thirty degrees to a surface, and so on.

Further, a circumference of the illustrated bracket 210 may be adjusted to fit a tool. The illustrated bracket 210 may be opened or closed, thereby either increasing or decreasing a circumference of the bracket 210 to achieve a desired size for slidably and removably coupling a tool thereto. For example, the bracket 210 may be opened such that a hooked knife 212 may be inserted into the bracket 210. Then, the bracket 210 may be tightened or closure such that the hooked knife 212 may be snugly and securely fit within the bracket 210.

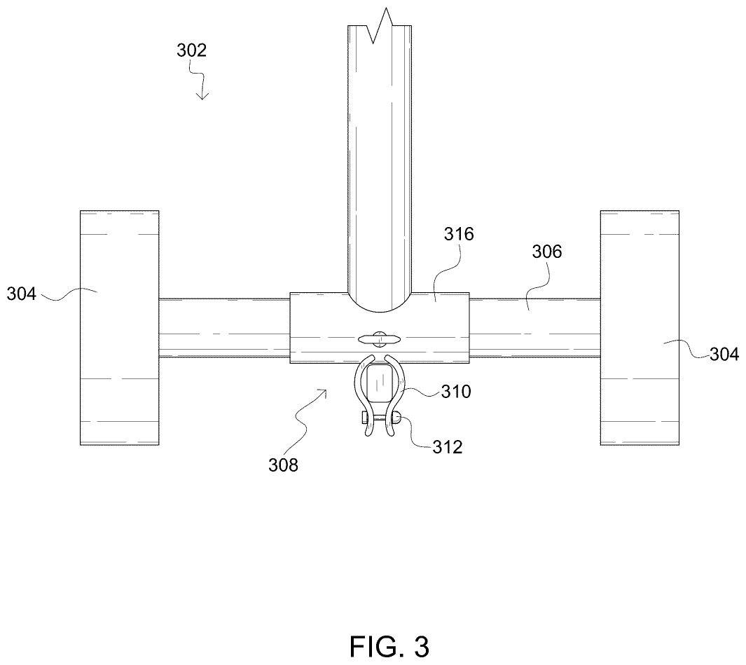

FIG. 3 illustrates a top plan view of a roofing trolley, according to one embodiment of the invention. There is shown a carriage body 302 including a first pair of wheels 304 disposed along an axle 306. The illustrated carriage body 302 also includes a knife mount 308 coupled to the axle 306. The knife mount 308 has a collar 316 with a bracket 310 coupled to the collar 316, and a hooked knife 312 coupled to the bracket 310 opposite the collar 316.

As illustrated, the carriage body 302, axle 306, and wheels 304 are sized and shaped to support the various parts and pieces of the roofing trolley (see e.g., FIG. 1, item 100). It is understood that the carriage body 302 may have any size and/or shape such as square, rectangular, round, etc. Further, it is understood that the axle 306 may be cylindrical and may have any length or circumference. It is also understood that the wheels 304 may have any circumference or width for supporting the roofing trolley.

The illustrated axle 306 is shown disposed interior to the carriage body 306, and interior to the first pair of wheels 304. Accordingly, the knife mount 308 is also disposed interior to the first pair of wheels 304. The knife mount 308 is disposed along the axle 306 interior to the wheels 304 so that a tool, such as a hooked knife 312, when mounted in the knife mount 308, may be controlled.

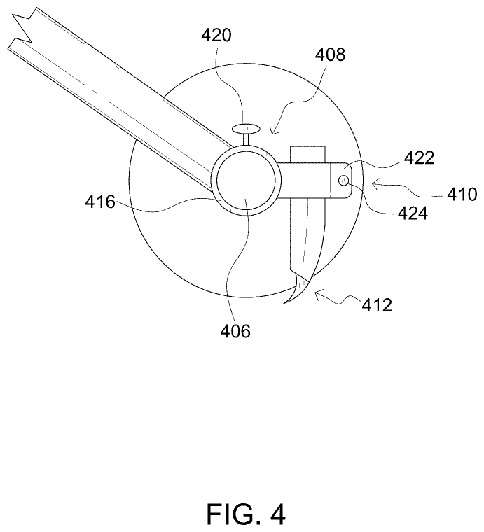

FIG. 4 illustrates a side elevational view of a hooked knife of a roofing trolley with a first wheel removed, according to one embodiment of the invention. There is shown an axle 406 with a knife mount 408 coupled to the axle 406. The knife mount 408 includes a bracket 410 with a hooked knife 412 coupled to the bracket 410. In addition, the knife mount 408 is comprised of a collar 416 with a wing screw 420, and the bracket 410 is comprised of a clamp 422 with a screw bolt 424.

As shown, the collar 416 may be fixedly coupled to the knife mount 408. The collar 416 may also be selectably rotatable about the axle 406. Accordingly, a position of the bracket 410, and thereby a position of a tool, such as the hooked knife 412, may be adjusted by adjusting the collar 416 of the knife mount 408 and/or the axle 406. Accordingly, the axle 406 and/or the knife mount 408 may be positioned so that the hooked knife 412 is oriented to cut in the same direction of the handle (see e.g., FIG. 1, item #114), such as backwards, rearwards, away etc. For example, in one embodiment of the invention, as the handle (see e.g., FIG. 1, item #114) is pulled in a backwards direction, the knife 412 will cut in a backwards direction. Accordingly, the hooked knife 412 includes a hooked blade that is oriented to cut in the direction of the handle.

Also shown, the collar 412 includes a wing screw 420 rotatably coupled to the collar 412. The wing screw 420 allows a circumference of the collar 412 to be adjusted. For example, as the wing screw 420 is rotated in a clockwise direction, a circumference of the collar 412 may decrease, and a position of the collar 412 may be tightened along the axle 406. Likewise, as the wing screw 420 is rotated in a counterclockwise direction, a circumference of the collar 412 may increase, and a position of the collar 412 may be loosened along the axle 406.

Further, the illustrated bracket 410 includes a clamp 422 and a screw bolt 424 removably coupled to the clamp 422. In one embodiment, as the screw bolt 424 is tightened, a circumference of the clamp 422 decreases, and as the screw bolt 424 is loosened, a circumference of the clamp 422 increases. Accordingly, the clamp 422 may be tightened and secured around a tool that is inserted into the clamp and thereby slidably coupled to the knife mount 408, such as a hooked knife 412.

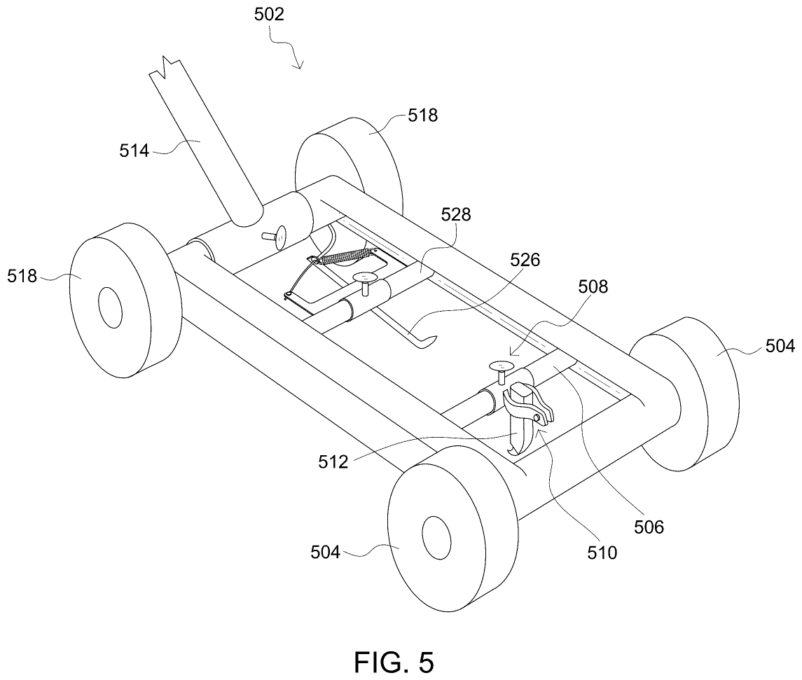

FIG. 5 illustrates a side perspective view of a roofing trolley showing a weld probe, according to one embodiment of the invention. There is shown a carriage body 502. The illustrated carriage body 502 includes a first pair of wheels 504 spaced apart from each other and a first axle 506 disposed interior to the first pair of wheels 504. The illustrated carriage body 502 also includes a second pair of wheels 518 spaced apart from each other and spaced apart from the first pair of wheels 504, and a second axle 528 disposed interior to the second pair of wheels 518. A knife mount 508 is shown coupled to the first axle 506 with a bracket 510 protruding from the knife mount 508. In addition, a hooked knife 512 is slidably coupled to the bracket 510 of the knife mount 508, and a weld probe 526 is coupled to the second axle 528 in functional communication with the handle 514.

As illustrated, one embodiment of the roofing trolley may have two pairs of wheels (504 and 518), each disposed on separate axles (506 and 528, respectively), all coupled to the carriage body 502. Accordingly, the carriage body 502 may be such as a frame for an automobile, a lawn mower, or a stroller. For instance, the carriage body 502 may be such as a frame of the 60V Max 22 in. (56 cm) Recycler Personal Pace Auto-Drive lawn mower by The Toro Company of 8111 Lyndale Avenue South, Bloomington, MB 55420-1196, which is incorporated by reference herein.

Additionally, the roofing trolley may have two separate tools each coupled to a separate axle (506 and 528). For example, as shown, the roofing trolley may have a hooked knife 512 coupled to the first axle 506 and a weld probe 526 coupled to the second axle 528. It is understood that the roofing trolley may have any number and any type of tool coupled to the axles (506 and 528), such as roofing tools. Further, it is understood that any type of roofing supply may be coupled to the roofing trolley, such as shingles.

The illustrated roofing trolley has a hooked knife 512 and a weld probe 526 coupled to its carriage body 502. As shown, it is understood that the weld probe 526 may be a seam probe for inspecting seams to make sure they hold properly. For instance, the weld probe 526 may be such as the Seam Probe of Primeline Tools at 3170 Orlando Dr Unit #1, Mississauga, L4V 1R5, Canada, which is incorporated by reference herein.

As further illustrated, the weld probe 526 is in functional communication with the handle 514. For instance, it is understood that the handle 514 may function as a trigger to activate the weld probe 526. Accordingly, the weld probe 526 may be in functional communication with the handle 514 such as by a Bowden cable.

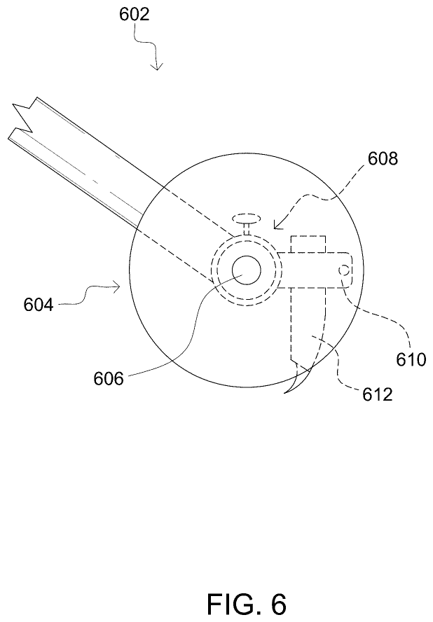

FIG. 6 illustrates a side elevational view of a roofing trolley, according to one embodiment of the invention. There is shown a carriage body 602 with a pair of wheels 604 coupled thereto. The carriage body 602 also has an axle 606 disposed interior to the pair of wheels 604. A knife mount 608 is coupled to the axle 606 and includes a bracket 610 with a hooked knife 612 coupled thereto. Accordingly, the axle 606 is in plane with an axis of the wheels 604.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the figures illustrate 2-and 4-wheeled versions of the roofing trolley, it is understood that the roofing trolley may have any number of wheels such as one or three. For instance, the roofing trolley may be a 3-wheeled cart. It is also envisioned that the roofing trolley may be pushed in a forward direction by the handle rather than pulled backwards. More, the roofing trolley may be on casters or other wheels that allow it to roll sideways or angularly.

Further, it is expected that there could be numerous variations of the design of this invention. An example is that the bracket may further include pointers or guides for cutting straight and consistently. Additionally, the bracket may be an L-shaped bar measuring and guiding. Even more, the knife may have a different design, and may have a cliff point, a drop point, tanto point, sheepsfoot, spear point, needle point, trailing point, gut hook, and so on.

Finally, it is envisioned that the components of the device may be constructed of a variety of materials, such as, but not limited to: metal, rubber, plastic, and wood. Even still, the knife may be comprised of a variety of metals, such as, but not limited to: carbon steel, stainless steel, tool steel, alloy steel, etc.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A roofing trolley, comprising:
a. a carriage body, including:
i. a first pair of wheels spaced apart from each other, and positioned and sized to support the carriage body; and
ii. an axle disposed interior to the first pair of wheels;
b. a knife mount coupled to the axle, and including a bracket protruding therefrom, wherein the knife mount is selectably rotatable;
c. a hooked knife slidably coupled to the bracket of the knife mount; and
d. a handle extending from the carriage body.

2. The roofing trolley of claim 1, wherein the knife mount is selectably rotatable about the axle.

3. The roofing trolley of claim 2, further comprising a collar fixedly coupled to the knife mount and selectably rotatable about the axle.

4. The roofing trolley of claim 1, wherein the axle is selectably rotatable and the knife mount is fixedly coupled to the axle.

5. The roofing trolley of claim 1, further comprising a second pair of wheels disposed opposite the first pair of wheels such that the axle is disposed between the first pair and the second pair.

6. The roofing trolley of claim 3, wherein the collar includes a wing screw rotatably coupled to the collar.

7. The roofing trolley of claim 1, wherein the bracket includes a clamp and a screw bolt removably coupled to the clamp.

8. The roofing trolley of claim 1, wherein the first pair of wheels are the only wheels.

9. The roofing trolley of claim 1, wherein the hooked knife includes a hooked blade that is oriented to cut in the direction of the handle.

10. The roofing trolley of claim 5, wherein the axle is coplanar with the rotational axis of the wheels.

11. A roofing trolley, comprising:
a. a carriage body, including:
i. a first pair of wheels spaced apart from each other, and positioned and sized to support the carriage body; and
ii. an axle disposed interior to the first pair of wheels;
b. a knife mount coupled to the axle, and including a bracket protruding therefrom, wherein the knife mount is selectably rotatable;
c. a hooked knife slidably coupled to the bracket of the knife mount;
d. a handle extending from the carriage body; and
e. a weld probe coupled to the axle and in functional communication with the handle.

12. The roofing trolley of claim 11, wherein the knife mount is selectably rotatable about the axle.

13. The roofing trolley of claim 12, further comprising a collar fixedly coupled to the knife mount and selectably rotatable about the axle.

14. The roofing trolley of claim 11, wherein the axle is selectably rotatable and the knife mount is fixedly coupled to the axle.

15. The roofing trolley of claim 11, further comprising a second pair of wheels disposed opposite the first pair of wheels such that the axle is disposed between the first pair and the second pair.

16. The roofing trolley of claim 13, wherein the collar includes a wing screw rotatably coupled to the collar.

17. The roofing trolley of claim 11, wherein the bracket includes a clamp and a screw bolt removably coupled to the clamp.

18. The roofing trolley of claim 11, wherein the first pair of wheels are the only wheels.

19. The roofing trolley of claim 11, wherein the hooked knife includes a hooked blade that is oriented to cut in the direction of the handle.

20. A roofing trolley, comprising:
a. a carriage body, including:
i. a first pair of wheels spaced apart from each other, and positioned and sized to support the carriage body;
ii. a first axle disposed interior to the first pair of wheels;
iii. a second pair of wheels spaced apart from each other, and spaced apart from the first pair of wheels; and
iv. a second axle disposed interior to the second pair of wheels;
b. a knife mount coupled to the first axle, including a collar fixedly coupled to the knife mount and selectably rotatable about the first axle and a wing screw rotatably coupled to the collar, wherein the knife mount is wherein the first axle is selectably rotatable and the knife mount is fixedly coupled to the first axle;
c. a bracket protruding from the knife mount, including a clamp and a screw bolt removably coupled to the clamp;
d. a handle extending from the carriage body;
e. a hooked knife slidably coupled to the bracket of the knife mount, wherein the hooked knife includes a hooked blade that is oriented to cut in the direction of the handle; and
f. a weld probe coupled to the second axle and in functional communication with the handle.
